(19) United States
(12) Patent Application Publication
(10) Pub. No.: US 2026/0152128 A1
(43) Pub. Date: Jun. 4, 2026

(54) FLEXIBLE STEP JOINT

(71) Applicant: Magna Exteriors Inc., Aurora (CA)

(72) Inventors: Jeffrey R. Johnson, White Lake, MI (US); Jeffry J. Zielinski, Metamora, MI (US)

(21) Appl. No.: 19/458,784

(22) Filed: Jan. 24, 2026

Related U.S. Application Data
(63) Continuation of application No. 17/703,510, filed on Mar. 24, 2022, now Pat. No. 12,559,036.
(60) Provisional application No. 63/165,473, filed on Mar. 24, 2021.

(51) Int. Cl. B60R 3/02; B60R 3/00

(52) U.S. Cl. CPC B60R 3/02; B60R 3/002

(57) ABSTRACT

A mounting system for a step of a vehicle. A step portion having a connecting flange. A load bearing adapter connected to the connecting flange via a lost motion connecting assembly for allowing substantially rigid connection when the step portion has a normal stepping load and allows tilting of the step when an obstacle is encountered which provides a load on the step in an upward direction. Wherein an upward force on the step portion allows upward movement of the step and returning it to the step position.

### CROSS-REFERENCE TO RELATED APPLICATIONS

This application is a continuation of U.S. application Ser. No. 17/703,510 filed Mar. 24, 2022 which claims priority to U.S. Provisional Ser. No. 63/165,473 filed on Mar. 24, 2021, the entire contents of which are incorporated herein by reference.

### TECHNICAL FIELD

The present disclosure relates to a flexible step joint for mounting of a side step or running board step to vehicle.

### BACKGROUND

Side steps, running boards and automatic running boards are used with higher vehicles such as Jeeps, pickup trucks and utility vehicles. Because the trucks extend down to allow users to more easily enter a higher height vehicle the steps may be subject to interference with ground obstacles such as a curb or the like. This problem is particularly an issue with off road vehicles where rocks, stumps, banks of ditches and other obstacles can find interference with the lower mounted or extending step or running board of a vehicle. If this situation presents itself the running board also becomes a rail like protector for the sides of the vehicle. Since the loads of such impacts are variable an encounter with a rock or the like could break mounts to the vehicle. This is particularly problematic when the step is an automated running board arrangement which includes motors four bar links and other expensive hardware.

Rock sliding and upward loading present a concern with that load being transferred to the links of a step mount for a vehicle. To take the load off of the links, the plan with the Gen 2 style rock slider is for the step to mate off to the frame, and transfer the load through the frame, and not the links. Tolerance of the linkages and the step make designing a touch or very close condition between the step and frame very difficult. This concept allows for the step to flex up, to contact the frame, without putting all of the loading on the linkages, while still maintaining rigidity for stepping loads in the down direction. This joint can be used on any running board application (Static, Gen 2, Gen V, etc.) where upward loading is expected, and can be distributed through a flexible joint to more structural components of the component/vehicle.

### SUMMARY

A mounting system for a step of a vehicle is provided. The mounting system includes a step portion having a connecting flange. A load bearing adapter is connected to the connecting flange via a lost motion connecting assembly for allowing substantially rigid connection when the step portion has a normal stepping load and allows tilting of the step when an obstacle is encountered which provides a load on the step in an upward direction. Wherein an upward force on the step portion allows upward movement of the step and returning it to the step position.

The present disclosure relates in part to a mounting system for a step of a vehicle. A step portion having two connecting flanges substantially along the same vertical plane is provided. The system includes a load bearing adapter for mounting the step including a first vertical leg, a second vertical leg and a horizontally extending intermediate leg connecting the first vertical leg and second vertical leg. Each of the first vertical leg and second vertical leg has an outboard and an inboard side or surface in relationship to a final attachment to a vehicle. A first flange of the connecting flanges is positioned next to the inboard surface of a first vertical leg and a second flange of said two connecting flanges is positioned next to said outboard surface of said second vertical leg. A first fastener assembly is provided for moveably fastening said first flange to said inboard flange of said first vertical flange said fastener including a biasing spring for providing biasing toward the outside and providing lost motion (shown at 11) to the inside. A second fastener assembly for moveably fastening said second flange to said outboard flange with a biasing spring interposed between a fastener head and the inboard side of the second vertical leg. An upward force on the step portion for instance in an encounter with a rock or other obstacle allows upward movement of the step and returning it to the step position thereby protecting mounting hardware or linkages mounted to the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present disclosure will become more fully understood from the detailed description and the accompanying drawings, wherein

FIG. 1 is a sectional view of the step mounting assembly.

FIG. 2A is a sectional view showing the operation of the compressive loads of the step mounting assembly.

FIG. 2B is a sectional view showing the operation of the compressive loads of the step mounting assembly.

FIG. 3A is a sectional view showing the operation of the step mounting assembly.

FIG. 3B is a sectional view showing the operation of the compressive loads of the step mounting assembly.

FIG. 4 is an example of an automated running board assembly.

FIG. 5 is a side view of attachment to a lower mount of a four bar linkage.

### DETAILED DESCRIPTION

The following description of the certain embodiment(s) is merely exemplary in nature and is in no way intended to limit the invention, its application, or uses.

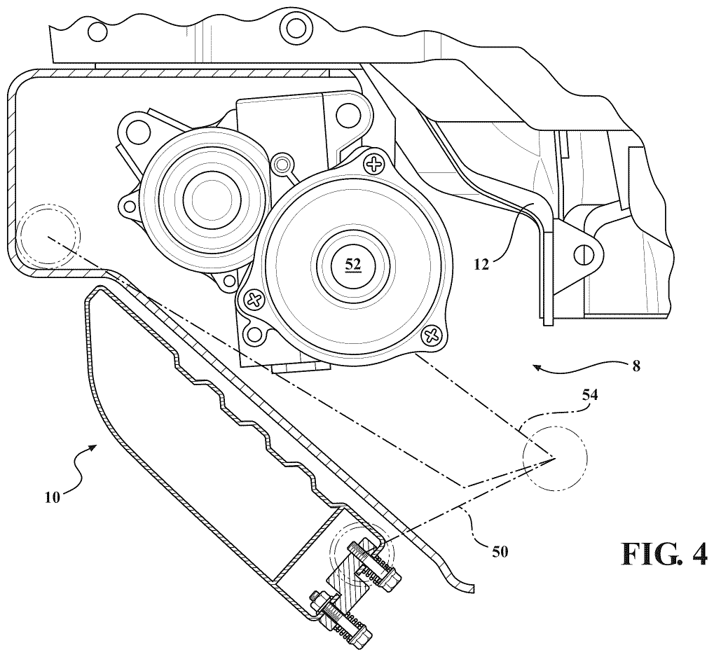

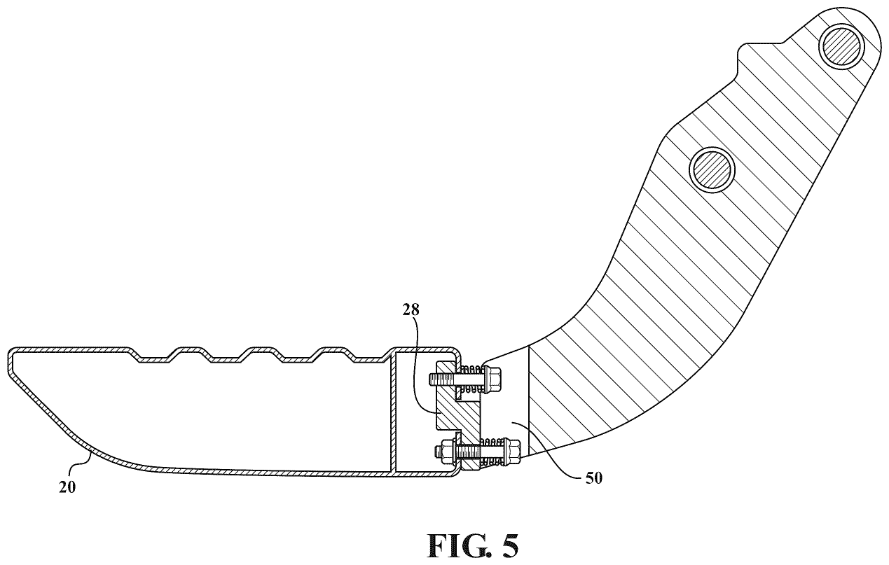

A step assembly with a mounting system generally shown at 10 for mounting a step to a vehicle 12. The step assembly 10 can be a powered automatic running board, a fixed step or a mechanical step for an SUV, pickup truck, utility van or vehicle or any other vehicle wherein it is desirable to have a step assist into a vehicle. As shown in FIG. 4 and FIG. 5, in one embodiment the step is connected to a four bar automatic running board system 8 as are known in the art and schematically shown in FIG. 4.

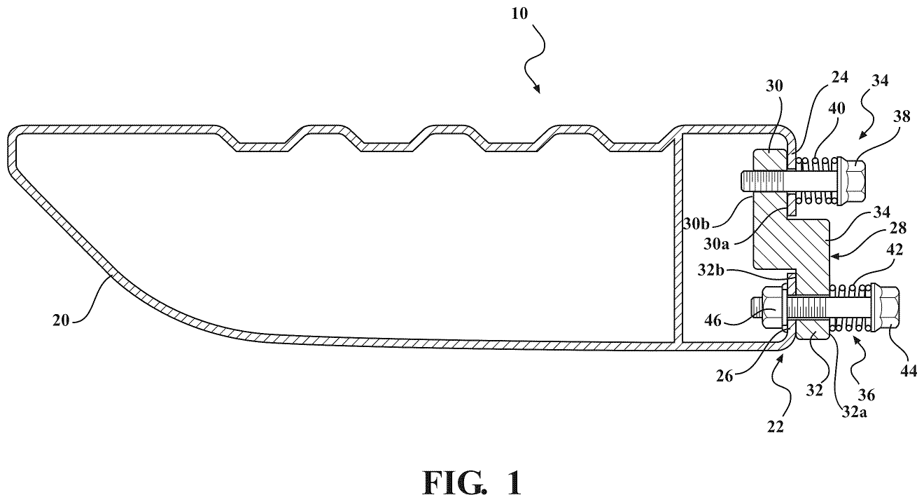

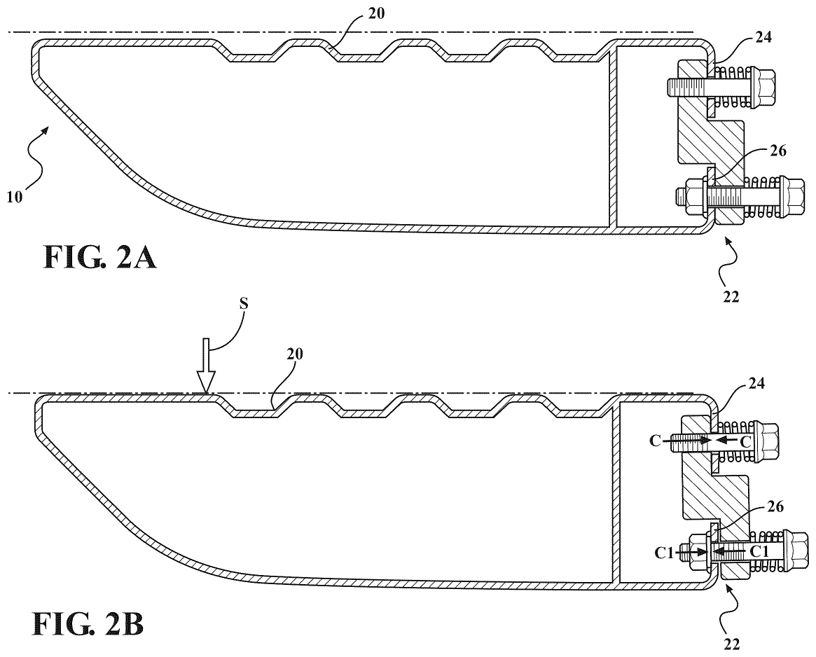

Referring now to the FIGS. 1 through 2B there is provided a step portion 20 having two connecting flanges generally indicated at 22. The connecting flanges include a first or upper flange 24 which extends downwardly and a second or lower flange 26 which extends upwardly. The upper flange 24 and lower flange 26 are configured such that they are aligned substantially along the same vertical plane. In a preferred embodiment, the step portion 20 is an extruded aluminum or roll formed steel which provides a ‘C’ shaped channel, and the flanges are integrally formed to provide an elongated rigid section for supporting a vehicle driver or passenger.

The step assembly 10 includes a load bearing adapter 28 including a first vertical leg 30, a second vertical leg 32 and a horizontally extending intermediate leg 34 connecting the first vertical leg 30 and second vertical leg 32. The first vertical leg 30 has an inboard surface 30a closest to the vehicle and an outboard surface 30b. Likewise, the second vertical leg 32 has an outboard surface 32b and an inboard surface 32a in relationship to a final attachment to a vehicle. The first flange 24 of said connecting flanges 22 is positioned next to the inboard surface 30a of the first vertical leg 30. The second flange 26 of the two connecting flanges 22 is positioned next to said outboard surface 32b of the second vertical leg 32. The intermediate leg 34 extends through an opening in the step portion 20 that is located between the first flange 24 and the second flange 26.

As shown in FIG. 5, the load bearing adapter is attached to the lower mount 50 of an automated running board linkage 8. As is known in the art the motor unit 52 of an automated running board powers the four bar linkage 54 to extend the step from a stowed to a deployed position. The step is usable for allowing a passenger to step on it to assist in entering or exiting the vehicle.

A first fastener assembly 34 is provided for moveably fastening the first flange 24 to the inboard surface 30a of said first vertical leg 30. The fastener assembly 34 includes a fastener 38 that extends through an opening in the first flange, and the assembly 34 includes a biasing spring 40 for providing biasing on the first flange toward the outside (away from the vehicle) and permitting lost motion to the inside (toward the vehicle).

A second fastener assembly 36 is provided for moveably fastening the second flange 26 to the second leg 32 at the outboard surface 32b, and a biasing spring 42 interposed between a head of a second fastener 44 and the inboard surface 32a of the second vertical leg 32. A weld nut 46 is provided on the outboard side of flange 26 to provide a threaded connection for the fastener 44 which extends through an opening in the flange 26.

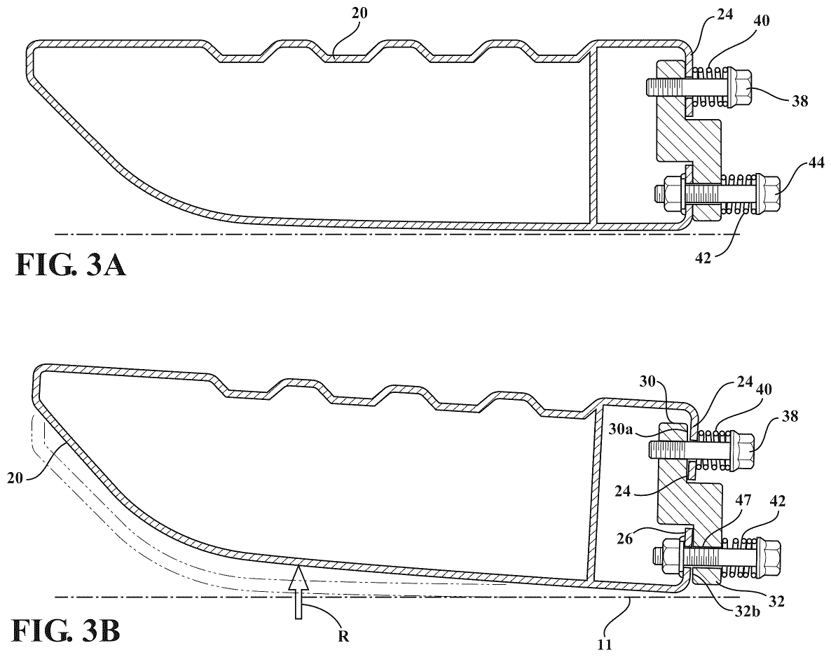

Referring now to FIG. 3, when an upward force on the step portion is encountered such as in a rockslide encounter, the attachment system allows upward movement of the step and returning it to the step position. As shown in FIGS. 3A and 3B, the first fastener 38 is threaded into a threaded opening in the first vertical leg and lost motion is allowed for compressing of the spring 40 on the inboard side of the flange 24 and inboard surface 30a of the first vertical leg 30 allowing the flange 24 and the first vertical leg 30 to separate. The second fastener 44 slides in a through bore 47 in the second vertical leg 32 which allows the flange 26 to tilt away from the outboard surface 32b of the second vertical leg 32. This allows the step 20 to tilt out of the way if there is interference with an obstacle (in the direction shown by the upward arrow R). This concept allows for the step to flex up, to contact the frame, without putting all of the loading on the linkages, while still maintaining rigidity for stepping loads in the down direction. As shown in FIG. 2B in operation the compressive load between the mating surfaces (as shown by the horizontal arrows C-C and C1-C1) of step and lower mount, to support a stepping load S (as shown by the downward arrow)

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A system for mounting a step to a vehicle, comprising:
a step portion having a first flange and a second flange, the first flange has a first opening through the first flange, and the second flange has a second opening through the first flange;
an adapter having a first leg and a second leg, the first leg having an outboard surface, an inboard surface opposite to the outboard surface and arranged next to the first flange, and the first leg also has a threaded opening, the second leg having an outboard surface arranged next to the second flange, the second leg has an inboard surface opposite to the outboard surface, and the second leg has an opening;
a first fastener assembly having a first fastener with a head and a first spring providing a biasing force on the first flange, the first fastener extending through the first opening and threadedly connected to the first leg in the threaded opening; and
a second fastener assembly having a second fastener with a head and a second spring providing a biasing force on the inboard surface of the second leg, the second fastener extending through the second opening and the opening of the second leg, wherein the step portion is deflectable by an upward force on the step portion that causes the first flange to compress the first spring and the first flange moves relative to the first leg, and wherein the second leg moves relative to the second fastener against the force of the second spring, and in the absence of the upward force, the first fastener assembly and the second fastener assembly provide forces on the step portion that maintain the step portion in a deployed position with the first flange abutting the first leg and the second flange abutting the second leg.

2. The system of claim 1 wherein the step portion includes an opening between the first flange and the second flange and part of the adapted extends through the opening so that the first leg is located inboard of the step portion and the second leg is located outboard of the step portion.

3. The system of claim 1 wherein the first flange has an inboard surface and an outboard surface, and the second flange has an inboard surface and an outboard surface, and the inboard surface of the first leg is received next to the outboard surface of the first flange, and the outboard surface of the second leg is received next to the inboard surface of the second flange.

4. The system of claim 1 wherein the first flange and the second flange are aligned in a vertical plane.

5. The system of claim 1 wherein the step portion includes a weld nut that is connected to the second flange adjacent to the opening in the second leg, and wherein the weld nut is threadedly coupled to the second fastener so that the second fastener does not move relative to the weld nut or the second flange.

6. The system of claim 5 wherein the second fastener is slidably received in the opening in the second leg, and the second leg is slidably movable relative to the second fastener.

7. A step for a vehicle, comprising:
a step portion having a first flange and a second flange;
an adapter having a first leg and a second leg, the first leg has an outboard surface, an inboard surface opposite to the outboard surface and arranged next to the first flange, and the first leg also has a threaded opening, the second leg has an outboard surface arranged next to the second flange, the second leg has an inboard surface opposite to the outboard surface, and the second leg has an opening;
a first fastener assembly having a first fastener fixed to the first leg and a first spring providing a biasing force on the first flange; and
a second fastener assembly having a second fastener slidable received in the opening in the second leg and fixed to the second flange, and the second fastener assembly also has a second spring providing a biasing force on the second leg, wherein the first flange is movable relative to the first leg against the force of the first spring, and the second leg is movable relative to the second flange and the second fastener against the force of the second spring.

8. The step of claim 7 wherein the first fastener is threaded into the threaded opening.

9. The step of claim 8 wherein the first flange includes an opening and the first fastener extends through the opening in the first flange.

10. The step of claim 7 wherein a nut is fixed to the second flange and the second fastener is threaded into the nut.

11. The step of claim 10 wherein the second flange includes an opening and the second fastener extends through the opening in the second flange.

12. The system of claim 7 wherein the first flange and the second flange are aligned in a vertical plane.

13. The system of claim 7 wherein the step portion includes an opening between the first flange and the second flange, and the adapter extends into the opening so that the first leg is received inside of the step portion and the second leg is located outside of the step portion.

14. A vehicle, comprising:
a vehicle connection area;
a step coupled to the vehicle connection area, the step including a step portion that has a first flange and a second flange;
an adapter having a first leg and a second leg, the first leg has an outboard surface, an inboard surface opposite to the outboard surface and arranged next to the first flange, and the first leg also has a threaded opening, the second leg has an outboard surface arranged next to the second flange, the second leg has an inboard surface opposite to the outboard surface, and the second leg has an opening;
a first fastener assembly having a first fastener fixed to the first leg and a first spring providing a biasing force on the first flange; and
a second fastener assembly having a second fastener slidable received in the opening in the second leg and fixed to the second flange, and the second fastener assembly also has a second spring providing a biasing force on the second leg, wherein the first flange is movable relative to the first leg against the force of the first spring, and the second leg is movable relative to the second flange and the second fastener against the force of the second spring.

15. The vehicle of claim 14 which also includes an automated running board linkage that is connected to the vehicle connection area and to the step, where one or both of the first fastener and the second fastener are connected to a link of the linkage, and which also includes an actuator that is operably coupled to the linkage to move the step relative to the vehicle.

16. The vehicle of claim 14 which also includes a linkage that is connected to the vehicle connection area and to the step, where one or both of the first fastener and the second fastener are connected to a link of the linkage.

17. The vehicle of claim 14 wherein the second fastener is attached directly to the vehicle at the vehicle connection area.

18. The vehicle of claim 14 wherein the first flange includes an opening and the first fastener extends through the opening in the first flange, and wherein the first fastener is threaded into the threaded opening.

19. The vehicle of claim 14 wherein the second flange includes an opening and the second fastener extends through the opening in the second flange, and wherein a threaded connector is fixed to the second flange and the second fastener is threaded into the threaded connector.

20. The vehicle of claim 14 wherein the step portion includes an opening between the first flange and the second flange, and the adapter extends into the opening so that the first leg is received inside of the step portion and the second leg is located outside of the step portion.
